(19) United States
(12) Patent Application Publication
(10) Pub. No.: US 2018/0019649 A1
(43) Pub. Date: Jan. 18, 2018

(54) IN-LINE MOTOR SOLENOID SWITCH

(71) Applicant: AMETEK, Inc., Berwyn, PA (US)

(72) Inventor: Rocky Lee George, Troy, OH (US)

(21) Appl. No.: 15/209,823

(22) Filed: Jul. 14, 2016

(51) Int. Cl. H02K 23/66; H02K 5/14; H02K 5/22; H02K 13/00

(52) U.S. Cl. CPC H02K 23/66; H02K 13/00; H02K 11/33; H02K 5/14; H02K 5/225

(57) ABSTRACT

Provided is an electric motor with an in-line solenoid switch comprising a motor housing including an electric motor, and a motor end cap configured for attachment to the motor housing. The motor end cap including an internal solenoid switch electrically coupled to the electric motor to energize the electric motor with a power supply.

### FIELD

This invention relates generally to a solenoid switch for an electric motor that is mounted in-line with the electric motor. The invention seeks to integrate a motor solenoid switch into the housing of the motor itself.

### BACKGROUND

Conventional motor solenoid switches are separate devices that are mounted to an outer surface of the motor casing. For example, solenoids switches are typically mounted to the side of the motor casing and then hardwired (e.g. with heavy duty wires) to the power terminals on the back of the motor. This configuration, however, is flawed. Mounting a solenoid switch the outer side surface of the motor casing results in a cumbersome and dangerous motor due to the exposed solenoid switch terminals extending from the casing and cumbersome wiring.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 shows a diagram of an electric motor having an in-line fully integrated solenoid switch.

FIG. 2 shows a view of a prior art electric motor with its end cap removed.

FIG. 3 shows a view of an electric motor having an in-line fully integrated solenoid switch

FIG. 4 shows an exploded view of an electric motor having an in-line fully integrated solenoid switch.

FIG. 5 shows an electrical schematic of the connections between the motor and the in-line fully integrated solenoid switch.

FIG. 6A shows a front view of an electric motor having an in-line fully integrated solenoid switch.

FIG. 6B shows a cross sectional view of the electric motor in FIG. 6A.

FIG. 7A shows a side view of an electric motor having an in-line fully integrated solenoid switch.

FIG. 7B shows a cross sectional view of the electric motor in FIG. 7A.

FIG. 8 shows an exploded view of an electric motor having an in-line solenoid switch bolted on to the back end of the electric motor.

FIG. 9A shows side view of the electric motor in FIG. 8.

FIG. 9B shows cross sectional view of the electric motor in FIG. 8

FIG. 10A shows front view of the electric motor in FIG. 8.

FIG. 10B shows a cross sectional view of the electric motor in FIG. 8.

### SUMMARY

In one embodiment, provided is an electric motor with an in-line solenoid switch comprising a motor housing including an electric motor, and a motor end cap configured for attachment to the motor housing. The motor end cap including an internal solenoid switch electrically coupled to the electric motor to energize the electric motor with a power supply.

In one embodiment, provided is a method of making an electric motor with an in-line solenoid switch. The method comprising mounting a solenoid switch inside a motor end cap, where the solenoid switch is electrically connected to electrical brushes of the electric motor. The method also includes mounting the end cap to an external case of the electric motor, where the electrical brushes are aligned with a commutator of the electrical motor.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Solenoid switches are widely used for electric motor applications. Typically, these solenoid switches are mounted (e.g. strapped) to the side casing of the electric motor where their electric terminals are exposed and connected to the exposed motor terminals. The present invention improves upon these conventional systems by implementing a solenoid switch that is fully integrated into the motor itself (i.e., it is not mounted to the side of the motor).

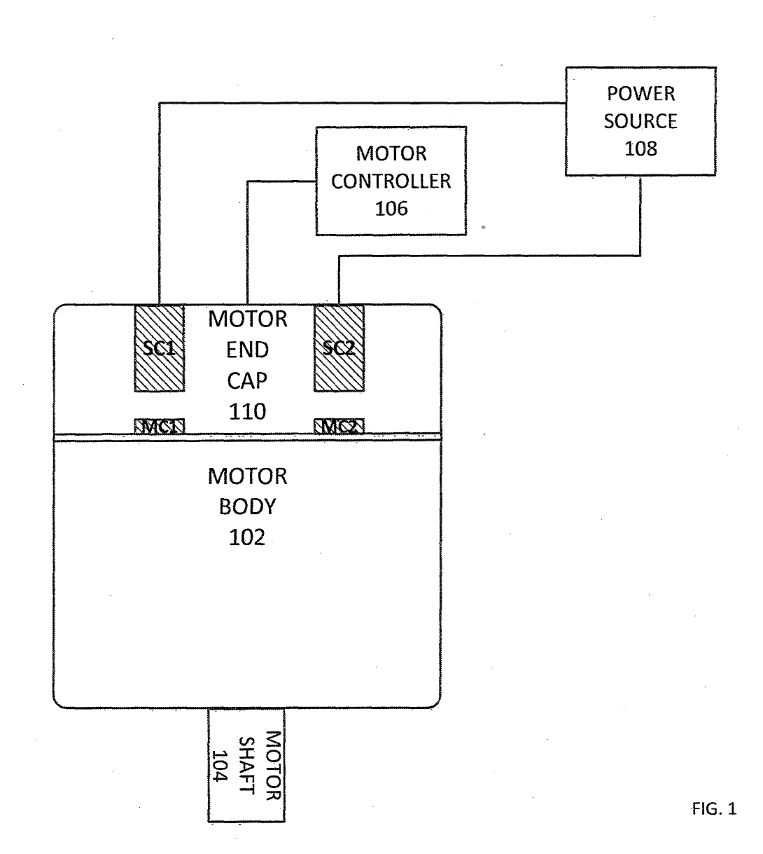

Shown in Applicants' FIG. 1 is an example of an in-line solenoid switch integrated into the motor housing. The electric motor includes a motor body 102 and a motor shaft 104. The electric motor also includes a motor end cap 110 which houses stationary electrical contacts SC1 and SC2 and moveable electrical contacts MC1 and MC2.

Motor controller 106 is connected to control terminals (not shown) on the external surface of end cap 110. These control terminals are electrically connected to solenoid coils (not shown) for moving moveable electrical contacts MC1 and MC2 to mate with stationary electrical contacts SC1 and SC2, respectively. Stationary contacts SC1 and SC2 are connected to terminals of a power source 108 which applies electric power to the electric motor. Movable contacts MC1 and MC2 are connected (not shown) to the motor coil through brushes. The power source and the electrical contacts within end cap 110 may be configured to apply a positive and a negative voltage in order to control the motor in both a forward and reverse direction, or to apply a single polarity voltage to control the motor in a single direction.

During operation, motor controller 106 controls movable contacts MC1 and MC2 to mate with stationary contacts SC1 and SC2 thereby conducting electrical current through the coil of the motor. This effectively starts the motor spinning in a given direction. To turn off the motor, the motor controller 106 controls the movable contacts MC1 and MC2 to disconnect from the stationary contacts SC1 and SC2 to stop flow of electrical current through the motor coils.

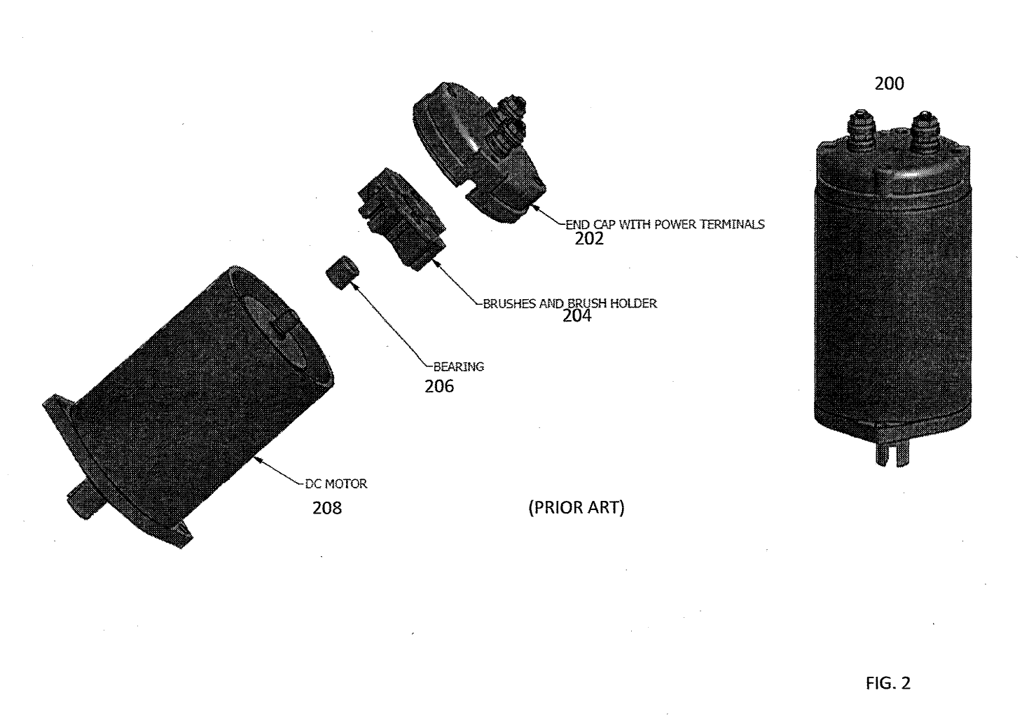

Shown in FIG. 2 is a conventional electric motor 200 which includes DC motor 208, a shaft bearing 206 which aligns the brushes within the motor, brushes and brush holder 204 for conducting electricity to the stator coil and end cap 202 which has external power terminals. As described before, these external power terminals are typically hard wired to the external power terminals of a conventional solenoid (not shown) switch is typically strapped to the side of DC motor 208.

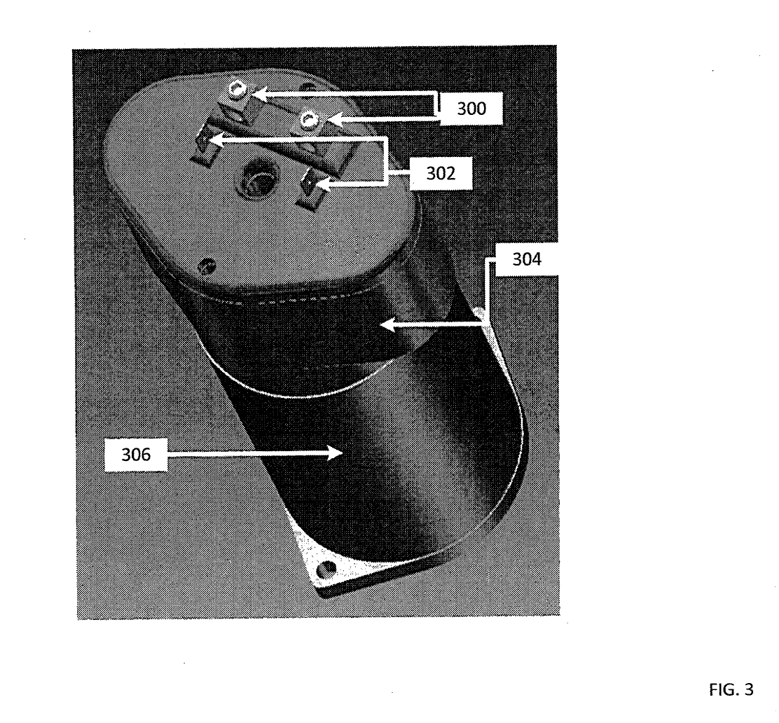

Applicants' system, however, replaces conventional end cap 202 shown in FIG. 2 with a specialized end cap 304 shown in FIG. 3. This specialized end cap 304 mounts directly to the motor body 306. More specifically, this specialized end cap includes external power terminals 300 to connect to power source 108, and external control terminals 302 to connect to motor controller 106.

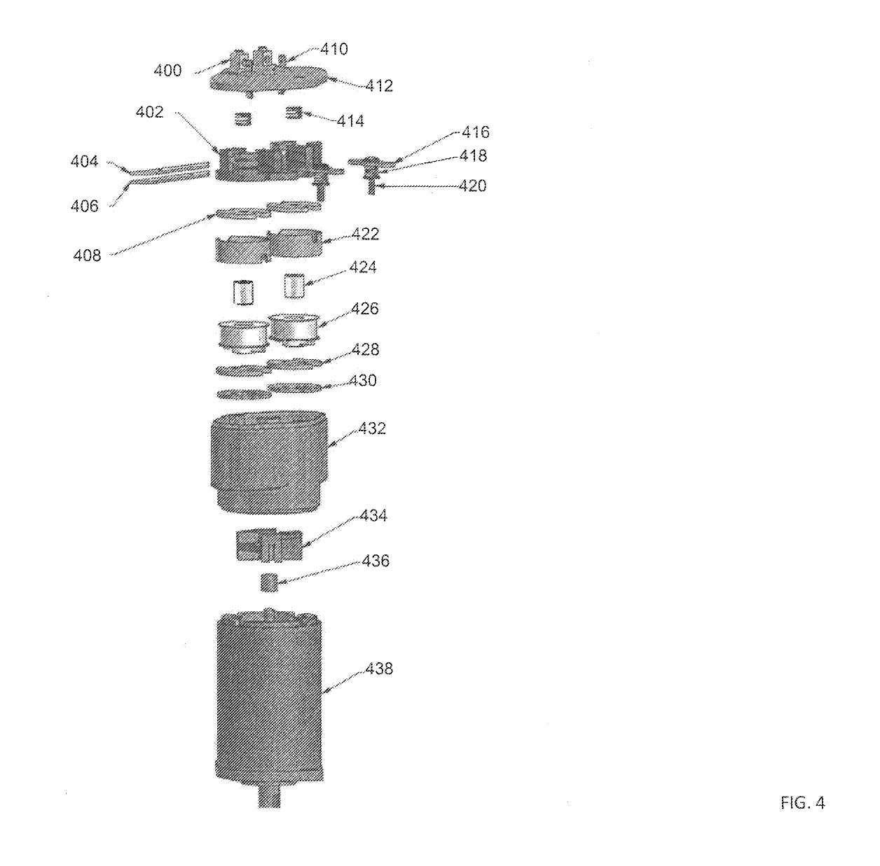

The internal components within specialized end cap 304 are shown in detail in exploded mechanical drawing of FIG. 4. FIG. 4 shows a specialized end cap switch housing 432 that encloses two independent moveable contacts to provide power to the DC motor 438. Power terminals 400 which are connected to the power source and coil terminals 410 which are connected to the controller are located on the external surface of housing end cap 412 which is mounted directly to switch housing 432.

Inside switch housing 432 are a number of internal components. These components include positive stationary contacts 404 which connect to the positive power terminal, negative stationary contact 406 which connects to the negative power terminal, stationary contact base 402 which holds the stationary contacts in place, moveable contact assembly 420 which includes moveable contact 416 and contact spring 418 for providing additional force to close the contacts during operation. Also included inside switch housing 432 are return springs 414 for opening the moveable contacts when a control signal is not applied to the coil assembly, top washer 408, sleeve 422 which are part of the magnetic circuitry, moveable core 424 which moves the moveable contact assembly up and down in a vertical direction to make contact with the stationary contacts, coil assemblies 426 which independently maneuver the moveable contact assemblies up and down in a vertical direction by producing respective magnetic fields, bottom washers 428 which are part of the magnetic circuitry, and cork washers 430 which are used to keep the assembly compressed when it is mounted within switching housing 432. In addition, DC motor brush holders 434 align the brushes with the commutator (not shown) within the motor and a DC motor shaft bearing 436 provides alignment of the shaft.

During motor operation, each of the moveable contact assemblies 420 may be controlled simultaneously or independently of one another to apply power to the DC motor. For example, both coil assemblies 426 may be energized to close the contacts and apply a voltage to the motor winding. Depending on the polarity of the applied voltage, the motor will either spin in the forward or reverse direction.

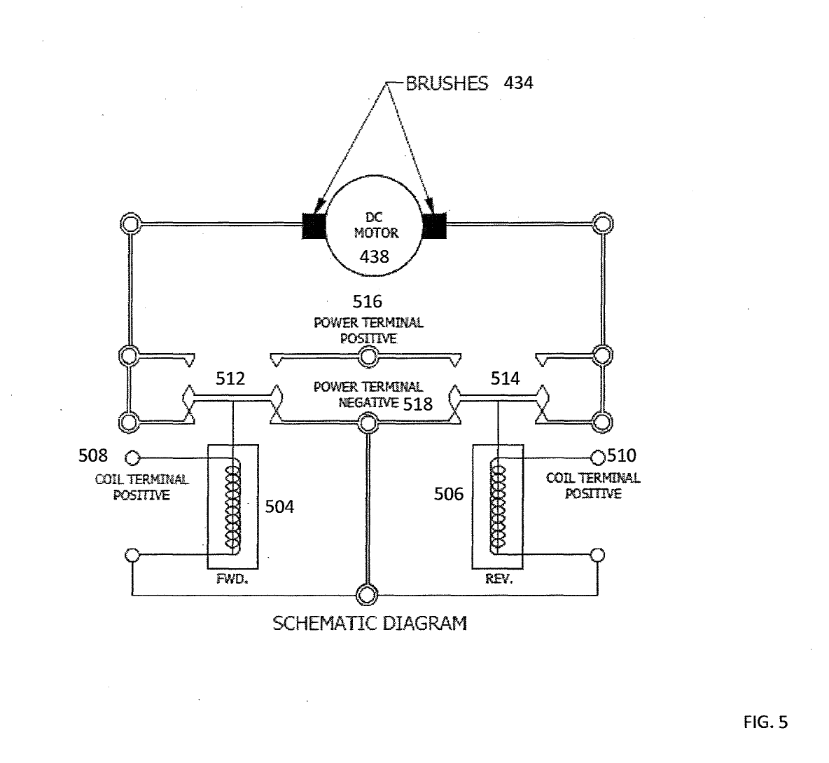

An example of the electrical connections that occur inside of the switch housing 432 are shown in FIG. 5. In general, brushes 434 of DC motor 438 are electrically connected to either the positive power terminal 516 or the negative power terminal 518 via moveable contacts 512 and 514. Moveable contacts 512 and 514 are controlled to move up and down in the vertical direction in the figure by an electric field generated by forward direction coil 504 and reverse direction coil 506. These coils are respectively controlled by a positive coil terminal 508 and by a negative coil terminal 510.

During operation, assuming neither of coils 504 or 506 are energized (i.e., neither 512 nor 514 are connected to the positive power terminal), the DC motor does not spin. For the controller to spin the DC motor in a forward direction, then voltage is applied to positive coil terminal 508 which induces a magnetic field in coil 504 and raises the moveable electrical contact 512 to make a connection with positive power terminal 516. This effectively turns on the DC motor to spin in the forward direction. During this operation, no voltage is being applied to the negative coil terminal 510. Therefore, moveable contact 514 remains in its resting position connected to the negative power terminal 518.

For the controller to spin the DC motor in the reverse direction, voltage is applied to the negative coil terminal 510 which induces a magnetic field in coil 506 thereby moving the moveable electrical contact 514 up to make a connection with the positive tower terminal 516. During this process, no voltage is applied to the positive coil terminal 508 thereby resulting in the moveable electrical contact 512 staying in its resting position connected to the negative terminal 518. This results in the current flowing in the opposite direction, and therefore the DC motor spinning in the reverse direction.

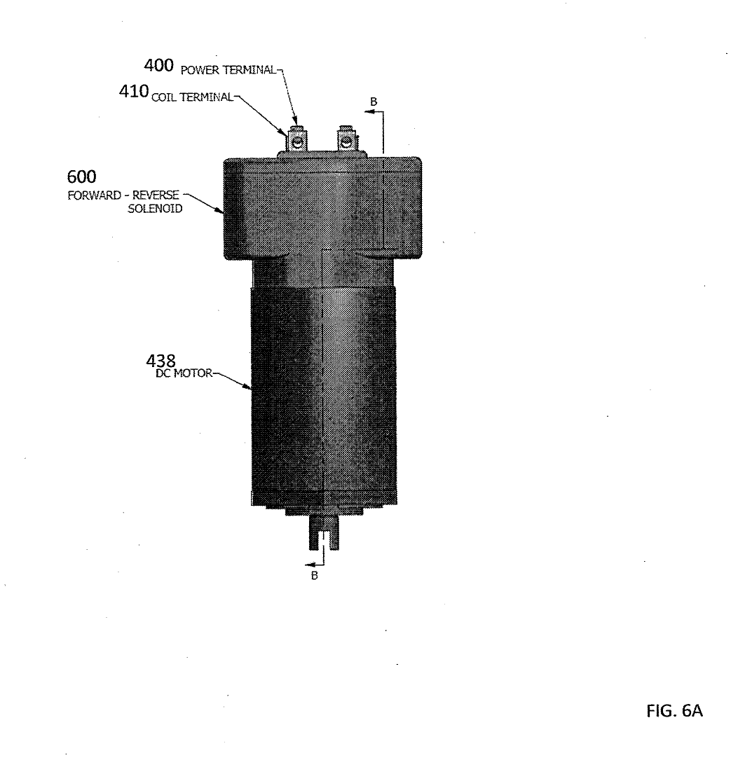

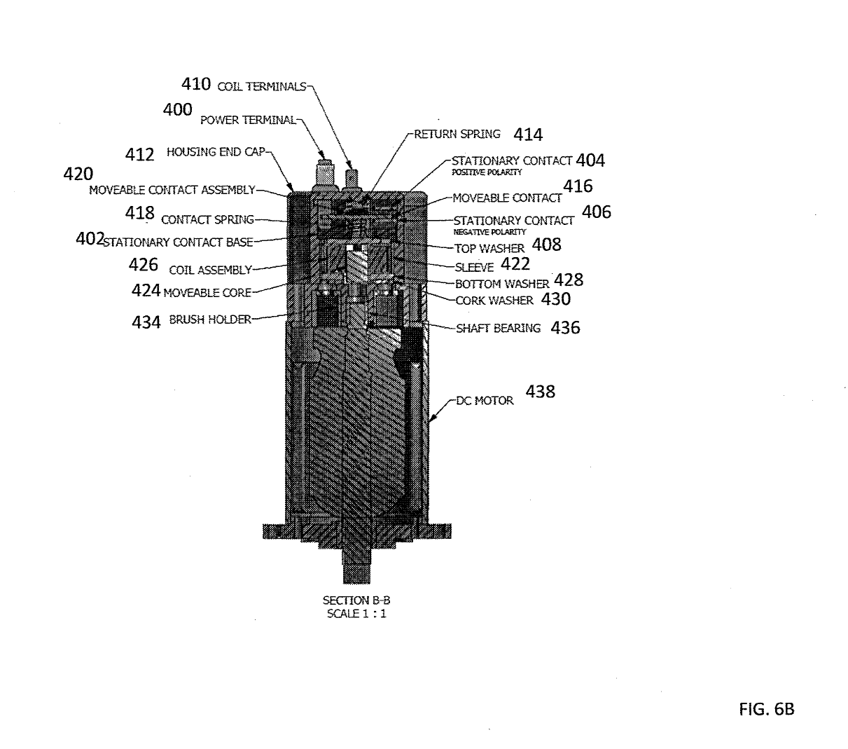

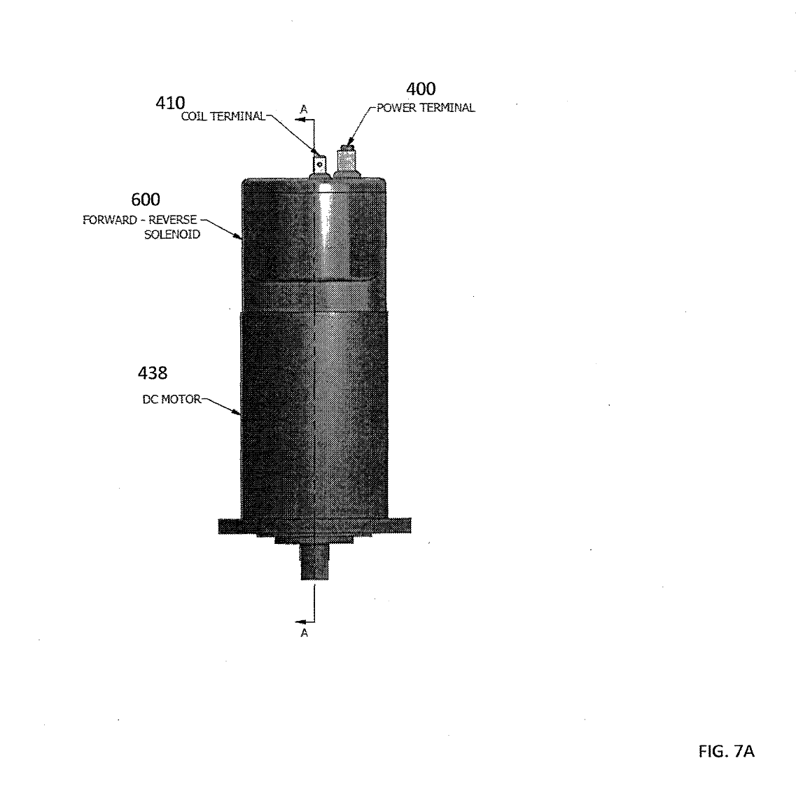

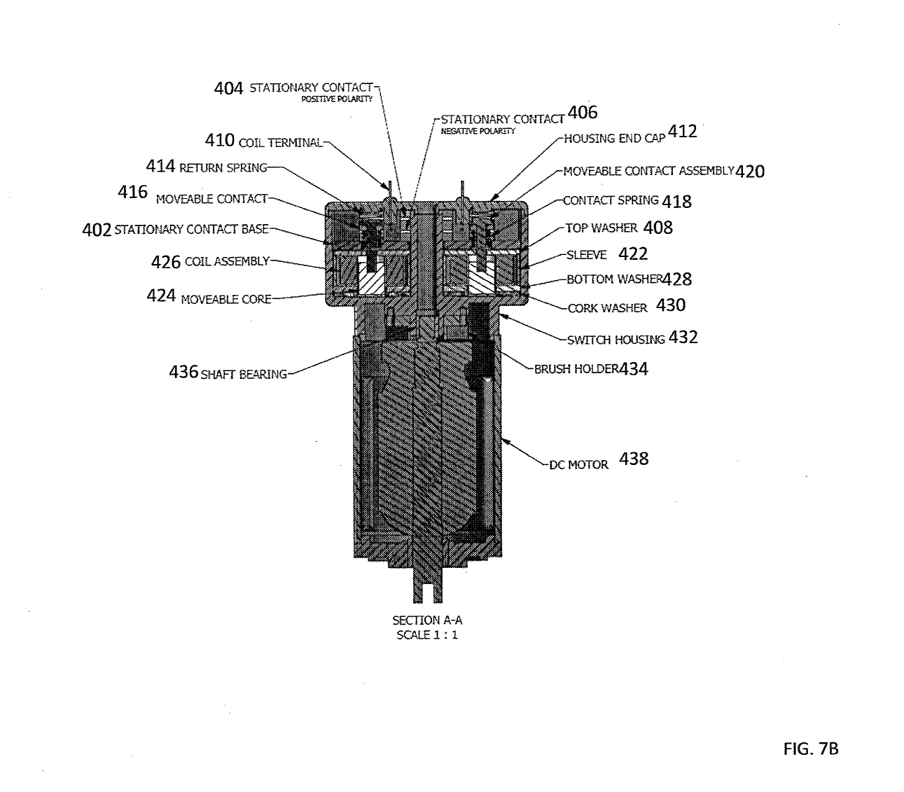

Although the solenoid switch was described in detail with respect to the exploded drawing in FIG. 4 and the electrical schematic in FIG. 5, further cross sectional views of the switch are shown in FIGS. 6B and 7B, respectively. For example, FIGS. 6A and 7A respectively show a front view and a side view of the motor. Corresponding FIGS. 6B and 7B show cross-sectional views of FIGS. 6A and 7A which further illustrate the components of the solenoid switch shown in FIG. 4. In these two cross sectional diagrams the two moveable contact assemblies are independently controlled by two different coil assemblies (two different solenoid coils). This is indicative of the electrical schematic diagram shown in FIG. 5.

The cross sectional image shown in FIG. 6B is a cross section along line B defined in FIG. 6A, whereas the cross sectional image shown in FIG. 7B is a cross section along perpendicular line A defined in FIG. 7A. Viewing the cross sectional image shown in FIG. 7A, when voltage is applied to either pair of the coil terminals 410, then that respective coil assembly generates a magnetic field thereby pushing the moveable contact assembly 420 up in the vertical direction to make electrical contact with the respective stationary contacts. When the moveable contact makes electrical contact with the stationary contact, then the circuit is complete at which point the power terminal will conduct current directly to the brushes of the motor in a specific direction (i.e., either in the forward or reverse direction). This allows the solenoid switch shown in FIG. 7A to control the DC motor 438 in either a forward or reverse working direction depending on the polarity of the voltage applied at the power terminals.

There are two basic methods for implementing the in-line solenoid switch described throughout this specification (i.e., retrofitting a motor with the specialized end cap, or manufacturing a new motor with the specialized end cap). Each of these methods are described below.

As for the retrofitting example, a conventional electric motor (see FIG. 2) may be fitted with the specialized end cap 304 (see FIG. 3) which includes all of the electrical components shown in FIG. 4. In order to retrofit an off the shelf DC motor with the specialized end cap, the old end cap 202 (see FIG. 2) along with the brushes/brush holder 204 and bearing 206 are removed from DC motor 208. The old end cap 202 with the power terminal is simply discarded. The brushes/brush holder 204 and bearing, however, are re-fitted into the specialized end cap of switch housing 432 shown in FIG. 4 such that the brushes make electric contact with the internal components of switch housing 432. This allows the electrical current to pass through the power terminals via the stationary and moveable contact assemblies to the motor brushes which ultimately power the motor.

Rather than retrofitting an off the shelf motor, a new motor may be manufactured to include the specialized switch housing 432 that includes the in-line solenoid switch. If the motor is manufactured to include this switch housing along with its internal components, then the steps of removing the end cap 202, brushes/brush holders 204 and bearing 206 are not necessary. These components can simply be integrated directly into switch housing 432 during the manufacturing process of the new motor.

In general, the shape and size of switch housing 432 is designed in order to properly accommodate the size of the DC motor housing. The specialized end cap 304 has roughly the same shape and size of the original end cap 202 with some variations. These variations may include side bulges which allow for more space for the various internal components of the solenoid switch which is now fully integrated in the motor. These bulges are shown in a specialized end cap 304 shown in FIG. 3, and also in switch housing 432 shown in FIG. 4. These bulges generally accommodate the various electrical components while not adversely affecting the manner in which the switch housing 432 is mounted to the DC motor housing (i.e., the portion of the specialized end cap that mounts to the DC motor housing has roughly the same shape as the original end cap). The mounting of the specialized end cap is also similar by utilizing the same screws or the like.

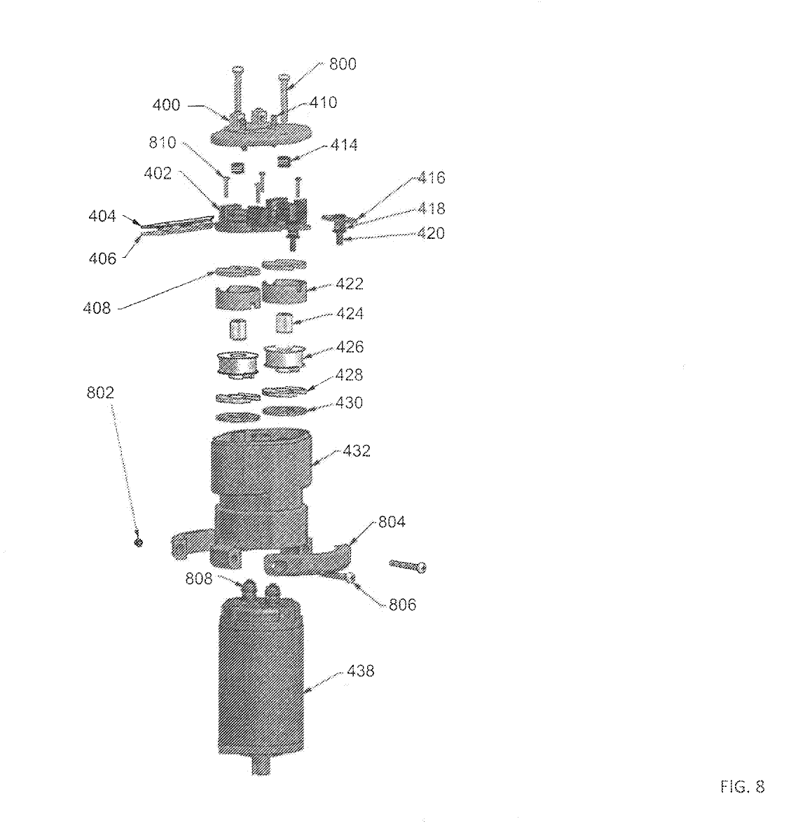

Another manner in which the solenoid switch can be mounted in-line with the electric motor is shown in FIG. 8 where the end cap of the motor does not have to be removed. FIG. 8 shows a configuration where the solenoid switch is mounted (i.e. clamped) to the end cap of the motor such that the switch electrically connects to the power terminals on the end cap of the motor.

It should be noted that the solenoid switch shown in FIG. 8 includes most of the same components of the solenoid switch shown in FIG. 4 with the exception of clamp 804, screws 800/806/810, lock nut 802 and motor power terminals 802. In this embodiment, switch housing 432 has a shape/size that is configured to mount directly onto the back end (e.g. the motor end cap) of the motor 438. This allows the installer to take an off the shelf motor 438, and fit it with an in-line solenoid switch without having to remove the end cap.

For example, the installer may simply fit the switch housing 432 over the end cap and power terminals 808 of the DC motor 438. The motor power terminals come in direct contact with (i.e. they are electrically connected to) the contacts in the solenoid switch, such that power may be supplied from the solenoid switch to the motor power terminals 808 during operation. In order to secure switch housing 432 onto DC motor 438, a clamp (having the shape of the motor end cap) is fit around the end cap and the bottom portion of the switch housing 432. The clamp is secured with screws 806 and lock nuts 802 to ensure adequate clamping force to hold the switch housing 432 onto the end cap of DC motor 438. It should be noted that screws 800 may also be provided to secure the switch housing cap onto the switch housing, and screws 810 may be used to secure the stationary contact base 402 in the switch housing.

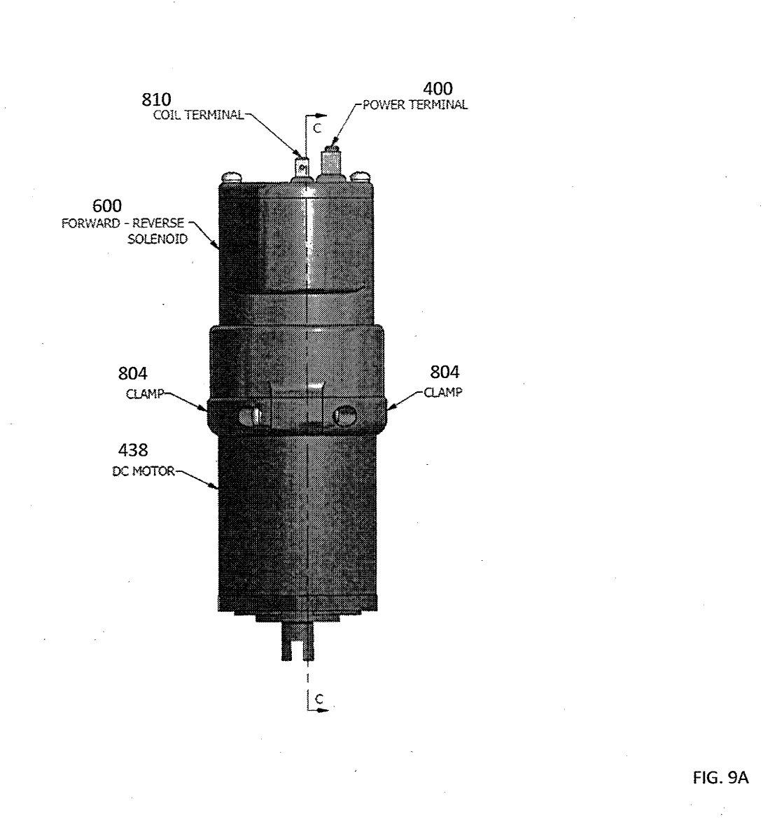

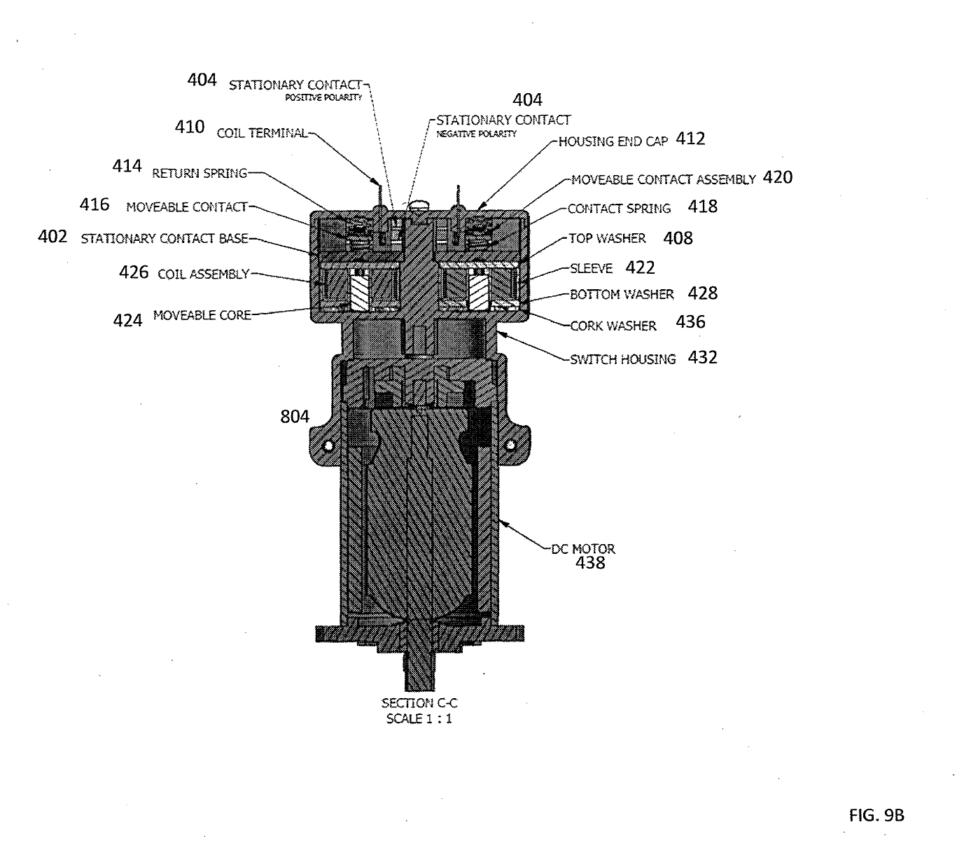

A side view of the in-line solenoid switch from FIG. 8 is shown in FIG. 9A where the clamp 804 is shown installed around the end cap of DC motor 438. FIG. 9B shows a cross sectional view of the in-line solenoid switch from FIG. 8 where the cross section of claim 804 is shown.

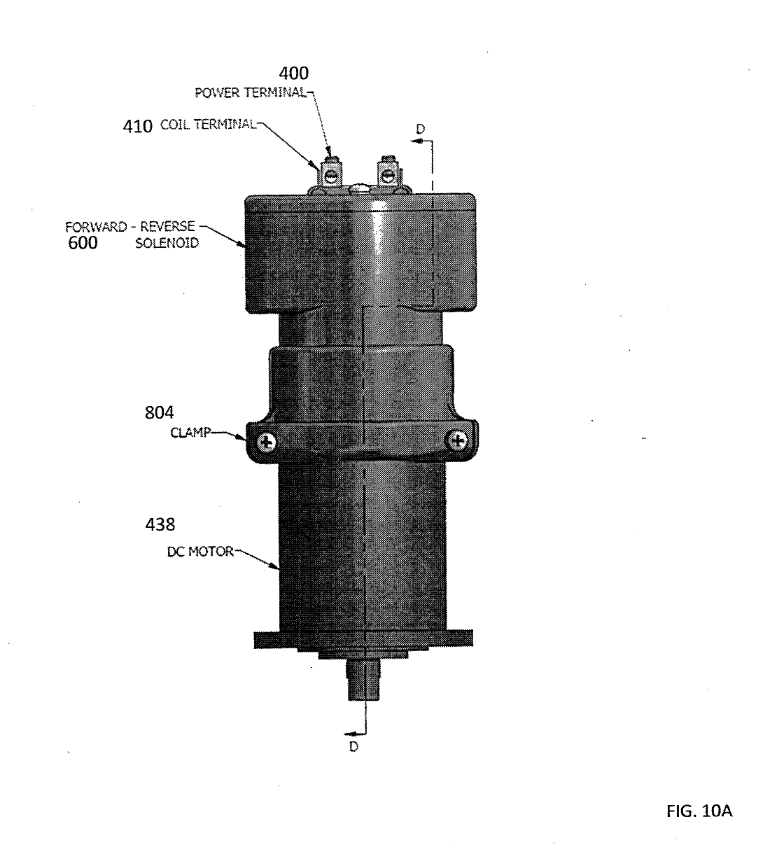

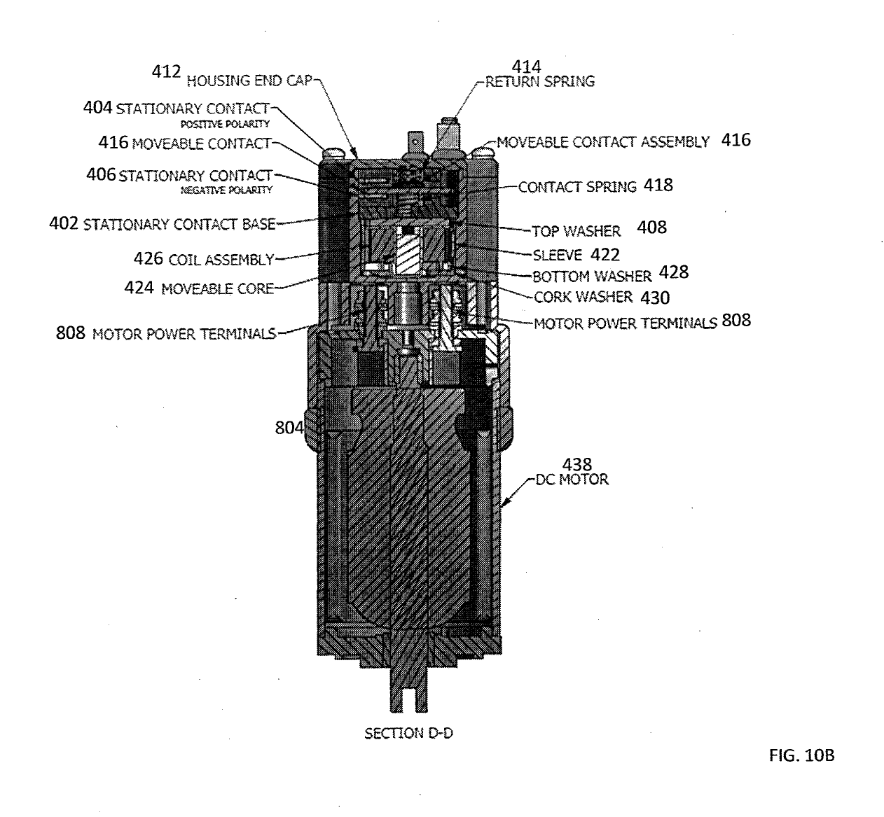

A front view of the in-line solenoid switch from FIG. 8 is shown in FIG. 10A where the clamp 804 is shown installed around the end cap of DC motor 438 using screws. FIG. 10B shows another cross sectional view of the in-line solenoid switch from FIG. 8 where the cross section of claim 804 is shown.

Although the figures described throughout the specification show that the DC solenoid switch is able to control the DC motor in both the forward and reverse direction utilizing two independent coil assemblies and two independent moveable contact assemblies, it is contemplated that only a single moveable contact assembly could be controlled by a single coil assembly. This may be the case in motor applications where the motor only needs to operate in a single direction. For example, the negative power terminal can be directly connected to the motor at all times. The positive terminal may then connected to the motor via a moveable contact assembly controlled by a single coil assembly. This allows the motor controller to simply turn the motor ON/OFF in a single direction.

A benefit of including an in-line solenoid switch is that the resultant motor is more streamlined. This is beneficial over the conventional DC solenoids which are manufactured separately and then mounted (i.e., strapped) to the side of an off the shelf electric motor. Strapping the DC solenoid to the side of the motor makes the overall package more cumbersome and also exposes more of the electrical terminals and wiring to the outside world. This invention does not have these deficiencies, because the solenoid switch is actually integrated into the motor housing itself.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in fewer than all features of a single disclosed embodiment. Thus the following claims are hereby incorporated into the Detailed Description, with each claim standing on its own as a separately claimed subject matter.

What is claimed is:

1. An electric motor with an in-line solenoid switch comprising:
a motor housing including an electric motor; and
a motor end cap configured for attachment to the motor housing, the motor end cap including an internal solenoid switch electrically coupled to the electric motor to energize the electric motor with a power supply.

2. The electric motor with the in-line solenoid switch of claim 1, further comprising
a brush holder within the motor end cap; and
electrical brushes of the electric motor mounted in the brush holder, the brush holder aligning the electrical brushes with a commutator of the electric motor.

3. The electric motor with the in-line solenoid switch of claim 1, further comprising
two power terminals positioned on an outer surface of the motor end cap, and electrically connected to power cables, the two power terminals providing electrical power to contacts of the internal solenoid switch; and
two control terminals positioned on the outer surface of the motor end cap, and electrically connected to control cables, the two control terminals providing control signals to a solenoid coil of the internal solenoid switch.

4. The electric motor with the in-line solenoid switch of claim 3, further comprising
two stationary electrical contacts mounted within the motor end cap, and electrically connected to external power cables; and
two moveable electrical contacts mounted within the motor end cap, electrically connected to the electric motor, and moveable by applied force of a solenoid coil of the internal solenoid switch,
wherein in response to a control signal received by the two control terminals, the solenoid coil is energized and physically moves the two moveable electrical contacts to mate with the two stationary electrical contacts resulting in energizing the electric motor.

5. The electric motor with the in-line solenoid switch of claim 4,
wherein the solenoid coil includes a positive solenoid coil applying force to one of the two moveable electrical contacts, and a negative solenoid coil applying force the other one of the two moveable electrical contacts.

6. The electric motor with the in-line solenoid switch of claim 1, further comprising:
a clamp positioned around the motor end cap and configured to attach the motor end cap to the motor housing by a clamping force.

7. The electric motor with the in-line solenoid switch of claim 4,
wherein the solenoid coil surrounds a moveable core that reacts with a magnetic field produced by the solenoid coil to apply force to the moveable electrical contacts.

8. The electric motor with the in-line solenoid switch of claim 1, further comprising
a motor shaft bearing mounted within the motor end cap to align a shaft of the electric motor.

9. The electric motor with the in-line solenoid switch of claim 1,
wherein the motor end cap is configured to have a size and shape compatible for mounting to the motor housing.

10. The electric motor with the in-line solenoid switch of claim 4,
wherein the motor end cap is configured to:
1) internally mount the electrical brushes, the two stationary electrical contacts, the two moveable electrical contacts, the return spring, and the solenoid coil, and
2) externally position the two power terminals and the two control terminals.

11. A method of making an electric motor with an in-line solenoid switch, the method comprising:
mounting a solenoid switch inside a motor end cap, the solenoid switch electrically connected to electrical brushes of the electric motor; and
mounting the end cap to an external case of the electric motor, the electrical brushes aligned with a commutator of the electrical motor.

12. The method of claim 11, further comprising
prior to mounting the end cap to the external case of the electric motor, removing an old motor end cap from the external case of the electric motor.

13. The method of claim 11,
wherein the motor end cap includes two power terminals positioned on an outer surface of the end cap, and two control terminals positioned on the outer surface of the motor end cap, and electrically connected to control cables, and
wherein the solenoid switch includes two stationary electrical contacts mounted within the motor end cap, and electrically connected to external power cables via the power terminals, and two moveable electrical contacts mounted within the motor end cap, electrically connected to the electrical brushes, and moveable by applied force of a solenoid coil and a return spring.

14. The method of claim 13, further comprising
mounting a return spring in the motor end cap to include a positive return spring applying force to one of the two moveable electrical contacts, and a negative return spring applying force the other one of the two moveable electrical contacts; and
mounting the solenoid coil in the motor end cap to include a positive solenoid coil applying force to one of the two moveable electrical contacts, and a negative solenoid coil applying force the other one of the two moveable electrical contacts.

15. The method of claim 13, further comprising
mounting the power terminals in the motor end cap to include a positive terminal and a negative terminal; and
mounting the stationary electrical contacts in the motor end cap to include a positive contact electrically connected to the positive terminal, and a negative contact electrically connected to the negative terminal.

16. The method of claim 11, further comprising
mounting the end cap to an external case of the electric motor by securing a clamp around the end cap and the external case.

17. The method of claim 13, further comprising
mounting the solenoid coil in the motor end cap to surround a moveable core that reacts with a magnetic field produced by the solenoid coil to apply force to the moveable electrical contacts.

18. The method of claim 11, further comprising
mounting a motor shaft bearing in the motor end cap to align a shaft of the electric motor.

19. The method of claim 11,
wherein the motor end cap is configured with a size and shape compatible to mounting to the external case of the electric motor.

20. The method of claim 13,
wherein the motor end cap is configured to:
1) internally mount the electrical brushes, the two stationary electrical contacts, the two moveable electrical contacts, the return spring, and the solenoid coil, and
2) externally mount the two power terminals and the two control terminals.
